(19) United States
(12) Patent Application Publication
(10) Pub. No.: US 2020/0001374 A1
(43) Pub. Date: Jan. 2, 2020

(54) Cutting Insert Applicable To Machining Tools And The Tool Bearing It

(71) Applicant: HERRAMIENTAS PREZISS, S.L., MONTGAT (Barcelona) (ES)

(72) Inventor: Guillem FARRARONS MALLEN, MONTGAT (Barcelona) (ES)

(73) Assignee: HERRAMIENTAS PREZISS, S.L., MONTGAT (Barcelona) (ES)

(21) Appl. No.: 16/050,052

(22) Filed: Jul. 31, 2018

(30) Foreign Application Priority Data
Jun. 29, 2018 (ES) 201830656

(51) Int. Cl. B23B 27/16

(52) U.S. Cl. CPC B23B 27/1607; B23B 2200/0438; B23B 2226/315; B23B 2200/32; B23B 2200/0471

(57) ABSTRACT

The present invention relates to a cutting insert applicable to machining tools and the tool bearing it. The insert (1) has a cutting edge (12) which can be completely sharp or can have a rounding between R=0.030 mm and 0.050 mm, with an angle of impact (123) between 68° and 90° in both cases, and a rounded chip breaker (13), both arranged in a layer of polycrystalline diamond (PCD) (11) at least 1 mm thick covering the entire cutting surface of the insert (1).

The tool includes a body (2) formed by a core (22) coupleable to the machining center, said core externally bearing a perimetral sleeve (21) housing the cutting inserts (1), with the layer of PCD (11) thereof being in direct contact with the sleeve (21).

The invention may include a hydraulic system (23) between the sleeve (21) and the core (22).

### TECHNICAL FIELD

The present invention relates to an insert and to a tool that can be used for rough machining and finishing (milling, drilling, boring, and reaming) of heat-resistant materials (titanium, inconel, nickel-based superalloys, cobalt-based superalloys, iron-based superalloys).

The scope of application of the invention is the machining of workpieces, particularly for the aerospace, automotive, or energy industries.

### STATE OF THE ART

Titanium, inconel, and other heat-resistant materials are materials that are extremely difficult to machine primarily due to the following reasons:
They have low thermal conductivity, which is a characteristic which means that virtually all the heat generated by friction between the material to be cut and the cutting edge of the insert during machining is transferred to the cutting edge, causing said edge to easily reach temperatures of up to 600° C. At that temperature titanium has a high reactivity, such that the chip generated during cutting process may end up being welded back to the workpiece due to the effect of the temperature itself
They have a low Young's modulus, which means that the material bends due to the high shear forces generated and attacks the cutting edge, damaging it by pushing against it from the rear portion of the insert.
Lack of the effect known as the “built up edge”, which are accumulations of material in front of and above the cutting edge. This characteristic means that it is possible to work at low cutting speeds to achieve good results, but at the same time it generates higher shear forces, which again lead to the aforementioned bending due to the low Young's modulus mentioned above.

The existing solutions for machining heat-resistant materials such as titanium or Inconel, for example, by chip removal currently depend on tungsten carbide tools (or tools more commonly known as hard metal tools or carbide tools).

Attempts have been made to use ceramic material or PCD cutting inserts, but the incorporated architecture did not allow for solving problems associated with the current system which utilizes hard metal composite materials such as tungsten carbide inserts. Given the lack of any technical resolution, there is currently no solution with PCD inserts similar to that of the invention.

The tools used today for machining heat-resistant materials are typically made of indexable tungsten carbide inserts assembled on a steel body (as a type of ring) for of the rough machining of large chip volumes. There are also (monoblock) solid carbide tools workpiece finishing tools.

Tungsten carbide also has a series of thermal and mechanical drawbacks, primarily its low thermal conductivity. This means that it does not sufficiently dissipate the heat generated while cutting, and the cutting speed must be limited (generally to 50 m/min).

On the other hand, the quality criteria required in the most demanding industries, such as the aerospace industry, make it necessary to remove an insert or tool even when the wear that is sustained is actually minor (in the order of 200 to 300 microns). Therefore, the mean service life of a tungsten carbide insert under these conditions rarely reaches one hour.

In other words, considering on one hand the low cutting speed to which tungsten carbide is limited combined with its short service life, the productivity that is obtained with these hard metal inserts is considerably low, and they furthermore require constant maintenance and large number of spare workpieces in stock.

Furthermore, users of the current system (which utilizes tungsten carbide inserts) cannot obtain maximum performance out of the machinery they use. This is due to the fact that the machinery would be able to work at higher cutting speeds without losing torque as a result. However, the thermal and mechanical limitations of tungsten carbide do not allow this.

The applicant does not know of any method or machining center similar enough to the invention so as to affect its novelty or inventive step.

### BRIEF DISCLOSURE OF THE INVENTION

The invention relates to a machining tool according to the claims. It also relates to the insert used therein. The different embodiments of the present invention solve the drawbacks of the prior art.

The invention is applied to a system for machining by chip removal, being particularly advantageous for workpieces to be machined that are made of titanium, inconel or made of a material from the family of materials known as heat-resistant materials. Said system can be used for, among others, milling operations in rough machining, milling operations in finishing, drilling, boring, and reaming.

The purpose of this system is to solve problems associated with the machining of heat-resistant materials by chip removal where the combination of thermal and mechanical issues generated by said materials when they are machined with hard metal composites such as tungsten carbide leads to adverse work conditions, resulting in low productivity and poor performance.

The invention presents a solution in the form of a tool system consisting of two parts: on one hand the insert of the invention, and on the other hand the body of the tool housing it. As a result of this solution, it is possible to machine heat-resistant materials at much higher cutting speeds of 50 to 250 m/min, with a service life for each cutting edge between 30 and 480 minutes. This data is not limiting; in future developments of the invention both the cutting speed and the service life of the edge are expected to be improved.

The users of the tool of the invention can choose the work conditions depending on the type of workpiece or volume thereof which must be manufactured. At the same time, they will be able to work with all the capabilities offered in some manufacturers' machines, as discussed above.

In numerical terms, this translates into requiring up to 12 tungsten carbide inserts to achieve the same production per insert according to the invention. This means that energy and raw material costs for the inserts are lower as a result of their higher efficiency.

The cutting insert of the invention, which is particularly interesting for heat-resistant metal machining tools, is of the type which has a cutting edge, generally along its entire perimeter, and a chip breaker arranged after the cutting edge. Furthermore, it is characterized in that the cutting edge can be a completely sharp or rounded (honing or k-land type) edge, with an angle of impact (angle between the front face of the insert and the primary cutting angle) between 68° and 90°, whereas the chip breaker has a rounded cavity shape. Both are arranged in a layer of PCD (polycrystalline diamond) that is considerably thick (at least 1 mm thick) which covers the entire cutting surface of the insert (all the cutting edges and the chip breaker). Preferably, at least 50% of the insert is made with said layer of PCD, where the entirety of the insert could be made with said layer of PCD.

In a preferred embodiment, the chip breaker is accompanied by structural ribs to improve the impact strength of the cutting edge.

In turn, the machining tool comprises, for milling operations in both rough machining and finishing, a body formed by a core and a perimetral sleeve around the core. The core is the part that is coupleable (by any known method) to the machining center and bears the sleeve on the outside thereof. Said sleeve houses at least one cutting insert (generally several on its entire surface) as described. In a particularly novel manner, the layer of PCD of each insert is in direct contact with the sleeve (generally made of steel or aluminum).

The composition could also be a monoblock type. In this type of composition, the sleeve and the core form a single body, generally made of steel. This monoblock type configuration can be applied to any of the tool variants (for milling, drilling, boring, and reaming), depending on the characteristics and needs of the operation to be performed.

When the insert is polygonal, it preferably comes into contact with the sleeve on at least two walls or sides of the polygonal layer of PCD. If the insert is circular or curved, it preferably comes into contact with the sleeve on at least 25% of the perimetral surface of the layer of PCD.

The core is preferably arranged along the entire sleeve, such that it provides greater rigidity to any of the variants of the system, with or without a hydraulic system.

In a preferred embodiment, the body of the tool comprises a hydraulic system capable of providing the assembly with a damping and reducing effect which damps and reduces the resonance caused by the work frequency to which the tool is subjected during the cutting process.

Other variants will be discussed at other points of the specification.

### DESCRIPTION OF THE DRAWINGS

The following drawings are included to better understand the invention.

FIG. 1 shows a side view of three examples of a machining tool with the corresponding examples of an insert of the invention.

FIG. 2 shows a cross-section of the cutting area of an example of an insert, with details of the cutting edge and the chip breaker.

FIG. 3 shows perspective views of two embodiments of the inserts.

FIG. 4 shows a detail of the cutting of a workpiece by means of the insert.

FIG. 5 shows a schematic depiction of the dissipation of the heat generated while cutting.

FIG. 6 shows a side view of the tool variant with a hydraulic system.

### EMBODIMENTS OF THE INVENTION

An embodiment of the invention is very briefly described below as an illustrative and non-limiting example thereof.

The embodiment of the invention shown in the drawings consists of a tool system formed by two parts.

A first part is the insert (1) of the invention. The insert includes a layer of PCD (11), i.e., polycrystalline diamond, and a novel architecture which encompasses the thickness of the layer of PCD, the geometry of the cutting edge (12), and the geometry of the chip breaker (13).

The second part is the body (2) of the tool of the invention housing the inserts (1). The body (2) is made up of an outer part referred to as “sleeve” (21), which is the part that houses the inserts (1), and also an inner part referred to as “core” (22), which is housed in the sleeve (21) and at the same time connects the tool with the spindle (3) of the machining center.

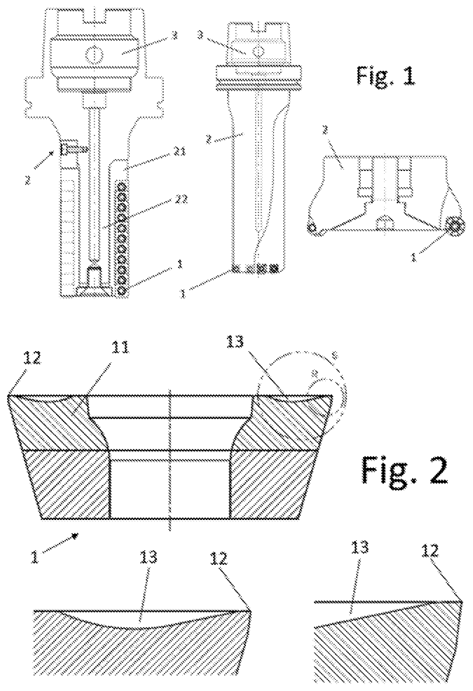

FIG. 1 depicts the composition of the tool as a whole, where the insert (1) can be seen assembled on the outer sleeve (21) made of aluminum or steel as a type of ring which is in turn assembled on the core (22), also made of steel.

It is important to point out that in the invention, the core (22) is a shaft housed in the sleeve (21) and occupies a large part of the length thereof (not less than 75%) to offer greater rigidity to the entire assembly. This translates into less vibration at high work speeds and loads.

The insert (1) shown in FIG. 2 comprises the layer of PCD (11), which is considerably thick, ranging from 1 mm to the entire thickness of the insert itself. This layer of PCD (11) covers the entire surface of the insert (1) such that it connects the cutting edge (12), which is directly in contact with the titanium, inconel or heat-resistant material to be cut, with the sleeve (21) of the tool.

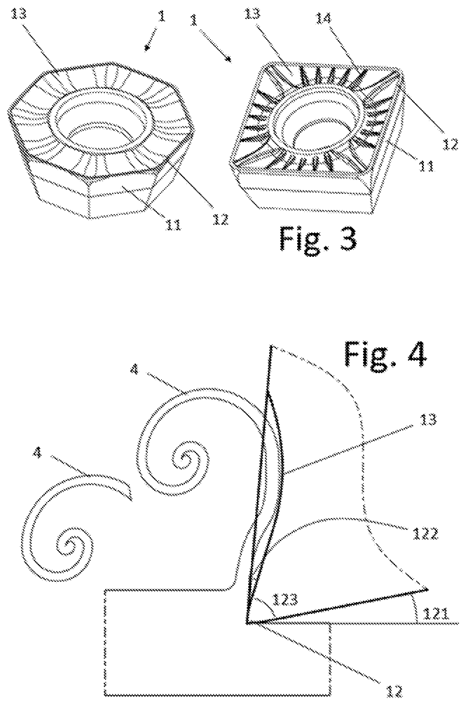

Geometrically and dimensionally speaking, the insert (1) may have a wide range of shapes and sizes (FIG. 3). As far as shapes are concerned, it can be square, octagonal, hexagonal, pentagonal, rhombus-shaped, triangular, circular, etc. As far as the dimensions are concerned, they will be in accordance with the needs of the tool and workpiece to the machined.

The layer of PCD (11) where the cutting edge (12) which will be in direct contact with the material to be cut (usually titanium, inconel or other heat-resistant materials) is located, will furthermore be responsible for dissipating the heat generated during the process. To that end, the high thermal conductivity of the PCD has a much higher transfer rate than that of the hard metal composites such as tungsten carbide. In the case of the PCD, the thermal conductivity reaches up to 543 W/m·K compared to the 110 W/m·K of tungsten carbide.

The cutting area, where the cutting edge (12) comes directly into contact with the workpiece to be machined, is where heat is generated by friction between the two materials. In this area, the temperature can easily reach 600° C., such that it is completely necessary to reduce said temperature as quickly as possible. To that end, the heat conducting capacity of PCD, which is much greater than the heat conducting capacity of a hard metal composite such as tungsten carbide. As a result of the higher heat conducting capacity of the layer of PCD (11), the cutting edge (12) will always be kept at a lower temperature than the temperature at which the inserts of the state of the art are kept.

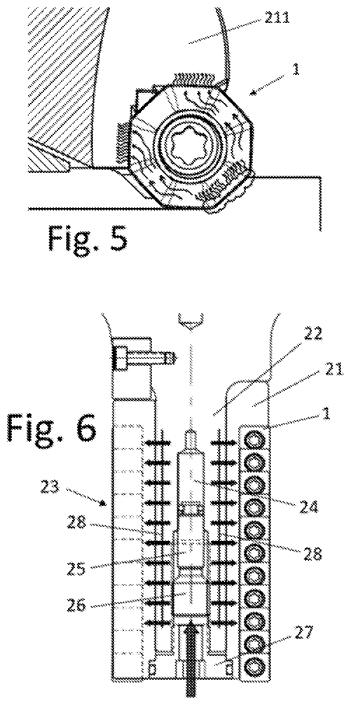

Furthermore, to improve heat transfer, the layer of PCD (11) will have surfaces in direct contact with the sleeve (21) (FIG. 5). A system capable of reducing the temperature of the cutting edge (12) operates in a highly effective manner compared existing systems within the current state of the art which utilize a combination of a hard metal composite insert (e.g., tungsten carbide) assembled on a steel body.

An insert comprising a hard metal composite such as tungsten carbide assembled on a steel body dissipates the generated heat towards the tool up to 6 times slower than the insert (1) of the invention. As a result, the temperature builds up on the cutting edge and degrades it prematurely. In the present case, the temperature does not build up on the polycrystalline diamond cutting edge (12) and the cutting edge does not experience premature degradation due to overexposure.

With regard to the architecture of the insert (cutting edge (12) and chip breaker (13)), the invention is based on the geometry of the cutting edge (12), which is particularly designed to impact the material to be cut, to be able to withstand the stress to which it is subjected under highly repetitive cycles on a heat-resistant material. At the same time, the friction forces generated between the insert (1) and the workpiece being machined are lower. To achieve this effect, the geometry applied to the cutting edge (12) is based on two embodiment types, on one hand, there are completely sharp edges, without any rounding of the honing or k-land type.

A high capacity of penetrating the material to be cut is achieved with said sharp edges, and the shear forces and the heat generated are thereby reduced, while at the same time achieving high finishing quality of the machined surface.

On the other hand, in machining operations where the finishing in the workpiece is not a requirement, given that additional operations will later be performed with finishing tools, the insert can be made with the rounded cutting edge of the type already discussed (honing or k-land). As a result of said rounding on the cutting edge, said cutting edge will be conserved for a longer time, offering the user of the tool a more competitive cost per cubic centimeter of cut chip.

Furthermore, the high thermal conductivity offered by PCD compared to that of carbide tools means that, even in the rounded cutting edge variant which itself generates more friction and therefore higher working temperatures, it does not affect the PCD insert in such a noticeable manner as that which occurs in the case of the insert of the state of the art.

In order to impact the workpiece to be machined with the insert (1) of the invention using the sharp cutting edge (12), a special preparation of the cutting edge (12) is required, making it capable of withstanding the forces to which it will be subjected. FIG. 4 shows a detail of the geometry of the cutting edge (12) which is made up of a periphery or primary angle (121), an axial angle (122), and an angle of impact (123) which will be the result of the primary angle (121) and axial angle (122). The angle of impact (123) determines how easily the insert (1) will penetrate the material to be cut. This angle of impact (123) has a value between 68° and 90°, which is distributed at a ratio between 0° and 12° for the axial angle (122) and between 0° and 10° for the periphery or primary angle (121), such that the geometry is too fragile for those values outside of this range.

In the cutting edge variant with a rounded edge, rather than a completely sharp edge, the insert will have a rounding between R=0.030 mm and 0.050 mm. The arrangement of the faces and angles will have the same ratio with respect to one another as in the edge variant with a sharp edge.

It must be taken into account that polycrystalline diamond has a very high Young's modulus, i.e., 890 GPa compared to the 650 GPa of tungsten carbide. For that reason, PCD is a more fragile material, hence the enormous importance of the aforementioned geometry being able to withstand the impact against titanium or heat-resistant materials. The cutting edge (12) will impact the material to be cut repeatedly, and these repetitions could even be more than 1200 impacts per minute, so the fatigue load to which the cutting edge (12) is subjected is high.

The chip breaker (13) is arranged after the cutting edge (12). The chip breaker (13) collects the chip that is produced and comes off the cutting edge (12). As a result of the completely rounded geometry of the chip breaker (13), the chip rolls up, producing as a result small-sized and easily discharged chip portions. The chip breaker (13) is accompanied by structural ribs (14) conceived to improve the impact strength of the cutting edge (12).

The chip (4) is generated once the insert (1) has impacted the workpiece and as it moves forward. The insert (1) sends this chip (4) to what is referred to as the chip breaker (13), which collects the chip (4) coming from the cutting edge (12) and the chip rolls up to obtain small-sized portions. The discharging of these portions from the cutting area and the tool is therefore quick, and the surrounding work area remains free of chips.

The detail of the behavior of the chip (4) once it comes off the cutting edge (12) can be seen in FIG. 4, where the chip (4) rolls up as a result of the geometry developed for the chip breaker (13). Said chip breaker (13) is characterized by being completely rounded, without walls offering resistance to the forward movement of the chip (4), such that it accompanies said chip along the path, pushing it along until it achieves the desired effect, which are small-sized spirals.

The sum of features of the cutting edge (12) and the chip breaker (13) generates a cutting geometry that produces less friction, and therefore requires smaller shear forces and at the same time lower working temperature. Together with a cutting material such as polycrystalline diamond, which has a high thermal conductivity, the temperature generated during the cutting process is very quickly and effectively reduced.

In turn and as indicated, the body (2) of the tool of the invention is made up of a sleeve (21) and a core (22).

The sleeve (21) serves as a housing for the inserts (1). Said sleeve (21) can be manufactured from several types of materials, for example aluminum or steel, depending on the size in the area where the inserts (1) are housed as a type of ring. The sleeve (21) housing the inserts (1) is responsible for absorbing the kinetic energy resulting from the collision and the heat conducted by the layer of PCD of the insert (1) from the cutting edge (12) to the walls of contact.

If the outer part of the sleeve (21) is made of aluminum, for larger diameters (generally greater than 80 mm) its high elasticity allows absorbing most of the kinetic energy produced in the collision between the insert and the material to be cut. The damage caused on the cutting edge (12) in each of the repeated impacts it sustains is thereby reduced. Furthermore, its high heat transfer rate allows for more effective temperature reduction.

If the sleeve (21) is made of steel, the Young's modulus is higher for smaller diameters (generally less than 80 mm) and provides the sleeve (21) with enough strength to withstand the impact repeatedly without it breaking or without its elastic limit being exceeded during this work.

The sleeve (21) can be made of other alloys and is not limited to the aforementioned steel and aluminum, such that it could take advantage of the properties these other alloys may offer the assembly.

There will always be minimum contact between the layer of PCD (11) of the insert (1) of the invention and the sleeve (21). The temperature generated in the cutting edge (12) during the cutting process is thereby quickly channeled to the sleeve (21), not allowing temperature to build up on the cutting edge (12) or the insert (1).

The core (22) is housed in the sleeve (21), with the inserts (1) of the invention being assembled therein, and connects the tool to the spindle of the machining center. The core (22) is manufactured from steel and occupies at least 75% of the length of the sleeve (21) in order to provide greater rigidity to the system. Furthermore, the core (22) can have a hydraulic system (23) that would provide it with two additional functions: assimilating or cancelling the tolerance between the shaft of the core (22) and the sleeve (21), preventing resonance phenomena and damping vibrations resulting from the cutting process.

Between the shaft of the core (22) and the hole of the sleeve (21) there is an h6(0.000/−0.013)/H7(0.021/−0.000) fit which provides a tolerance enabling assembly and disassembly. However, at the same time it generates minor play, which means that resonance may be produced between the two parts due to the work frequency to which the tool is subjected. The action of the hydraulic system (23) reduces the possibility of resonance. This effect is produced as a result of the action of compression of the oil or fluid located in a deformable chamber (24) of the hydraulic system (23) in the core (22). The chamber (24) is deformed by the action of a piston (25) tightened by an adjustable set screw (26) which, for the purpose of safety, is immobilized by a screw (27). The pressure generated in the chamber (24) diverts the fluid into a peripheral borehole (28) close to the outside of the core (22) and it deforms the outer wall of the core (22) to reduce tolerance. Therefore, the tightening of the set screw (26) is converted into the deformation of the wall of the core (22) and this can be controlled.

1. A cutting insert applicable to machining tools comprising a cutting edge (12) and a chip breaker (13),
wherein the cutting edge (12) is completely sharp or has a rounding between R=0.030 mm and 0.050 mm, with an angle of impact (123) between 68° and 90° in both cases;
wherein the chip breaker (13) has a rounded shape; and
wherein both the cutting edge and the chip breaker are arranged in a layer of polycrystalline diamond (PCD) (11) at least 1 mm thick covering the entire cutting surface of the insert (1).

2. The insert according to claim 1, wherein the layer of PCD (11) corresponds to at least 50% of the thickness of the insert (1), and preferably corresponds to the entire thickness of the insert (1).

3. The insert according to claim 1, with the chip breaker (13) thereof being accompanied by structural ribs (14) to improve the impact strength of the cutting edge (12).

4. A machining tool for heat-resistant metals comprising a body (2) housing at least one cutting insert (1) according to any of the preceding claims, with the layer of PCD (11) thereof being in direct contact with the body (2).

5. The tool according to claim 4, with the body (2) thereof being formed by:
a core (22) coupleable to the machining center, said core externally bearing
a perimetral sleeve (21) housing the cutting inserts (1) and being in direct contact with its layer of PCD (11).

6. The tool according to claim 4, with the sleeve (21) thereof being made of steel or aluminum.

7. The tool according to claim 4, with the insert (1) thereof being polygonal and coming into contact with the sleeve (21) on at least two walls of the layer of PCD (11).

8. The tool according to claim 4, with the insert (1) thereof having a curved section and coming into contact with the body (2) on at least 25% of the perimetral surface of the layer of PCD (11).

9. The tool according to claim 5, with the core (22) thereof being introduced into the sleeve (21) occupying at least 75% of the length of the sleeve (21).

10. The tool according to claim 5, comprising a hydraulic system (23) between the core (22) and the sleeve (21), formed by a deformable chamber (24) arranged in the core (22) which deforms the walls thereof by pressure of a piston (25) controlled by an adjustable set screw (26).
